(19) United States
(12) Patent Application Publication
(10) Pub. No.: US 2012/0076489 A1
(43) Pub. Date: Mar. 29, 2012

(54) Optical Amplifier Protection Switch

(76) Inventor: Bogdan Chomycz, Thunder Bay (CA)

(21) Appl. No.: 12/889,617

(22) Filed: Sep. 24, 2010

(51) Int. Cl. H04B 10/00

(52) U.S. Cl. 398/5

(57) ABSTRACT

The rapid switching of optical fiber communication between one or two working optical amplifiers and one protect optical amplifier is accomplished using fast optical fiber switching and alarm detection circuits that protects the loss of communication due to amplifier failure.

### FIELD OF THE INVENTION

The invention basically incorporates the casement of optical 1×2 switches along with electronic control and power circuitry to re-direct the optical signal to an protection fiber optic amplifier should one of the working fiber optic amplifiers fail.

### BACKGROUND OF THE INVENTION

An optical amplifier is a device that amplifies an optical signal without needing to convert the optical energy into electrical energy and then back again. The optical amplifier is usually placed in locations along a fiber route where there is a risk of signal degradation between the transmitting and receiving stations.

In general, the number of fibers needed for bi-directional communication is two. Thus, when optical amplifiers are utilized at remote locations, they are combined in pairs to amplify the optical signal in both directions. As they are located in remote areas of the fiber network, it may take a technical crew several hours, or even days, to restore communication traffic should one of the optical amplifiers fail. Therefore, the purpose of this invention is to provide a protective measure should one of these optical amplifiers fail.

### BRIEF DESCRIPTION OF THE DRAWINGS

Examples of the present invention are illustrated in the accompanying drawings. The accompanying drawings, however, do not limit the scope of the present invention. Similar references in the drawings indicate similar elements. The protection switch is shown enclosed with a dotted line. A triangle represents an optical amplifier. A rectangle represents the 1×2 optical switch.

FIG. 1 is a fiber path block diagram that shows the protection switch, 1×2 switch setting, in normal operation, with none of the working amplifiers failed.

FIG. 2 is a fiber path block diagram that shows the protection switch, 1×2 switch setting, should the eastbound working amplifier fail (106). Eastbound means the optical signal direction in the fiber is left to right in this diagram.

FIG. 3 is a fiber path block diagram that shows the protection switch, 1×2 switch setting, should the westbound working amplifier fail (107). Westbound means the optical signal direction in the fiber is right to left in this diagram.

FIG. 4 is a block diagram of the controls that operate the protection switch.

FIG. 5 is a table that shows the orientation of the optical switches in the protection switch in the four different orientations that the protection switch can be in.

### DETAILED DESCRIPTION OF THE INVENTION

The protection switch and the protective optical amplifier will remain in stand-by mode until one of the optical amplifiers generates a failure alarm to one of the input alarm termination points of the switch. Depending on which working optical amplifier fails; the switch controller will close the appropriate 1×2 optical switches components to re-direct the input optical signal to the protective optical amplifier.

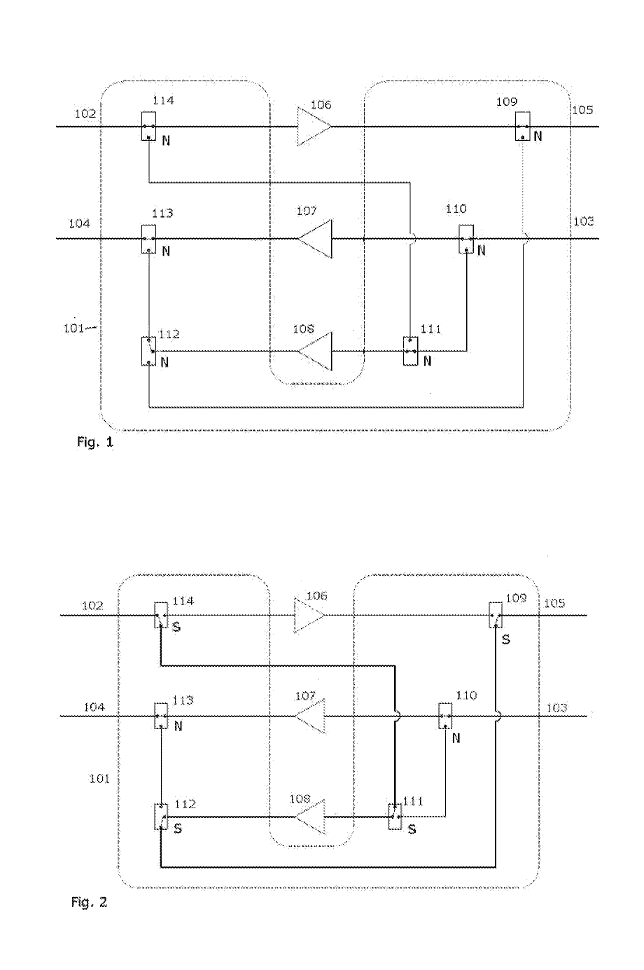

The protection switch, 101 (enclosed by the dotted line FIGS. 1,2 and 3) has two main inputs, an eastbound input 102, and a westbound input, 103. It also has two main outputs, and eastbound output 105, and a westbound output 104. 101 is connected to three optical amplifiers, a working eastbound amp, 106, a working westbound amp, 107, and a protection amp, 108. These are connected to the main inputs and outputs by six 1×2 switches, 109, 110, 111, 112, 113, and 114. All those switches are functioning in normal mode, indicated by “N”.

When in normal mode (FIG. 1), eastbound optical fiber signals at 102 go into the protection switch. There 114 passes that signal on to 106 where it is amplified, then it goes to 109 and out at 105. Then westbound optical signals at 103 go into the protection switch. There 110 passes that signal on to 107 where it is amplified, then it goes to 113 and out at 104. No optical signals make it to 108.

When the protection switch 101 is configured to protect eastbound amplifier 106 or if 106 fails (FIG. 2), the signal coming in from 102 is diverted by switch 114 to switch 111 which are in switch mode, indicated by a “S”, and sends the signal into amplifier 108. After amplification switch 112 sends the signal to switch 109, also in switch mode indicated by a “S”, and out 105.

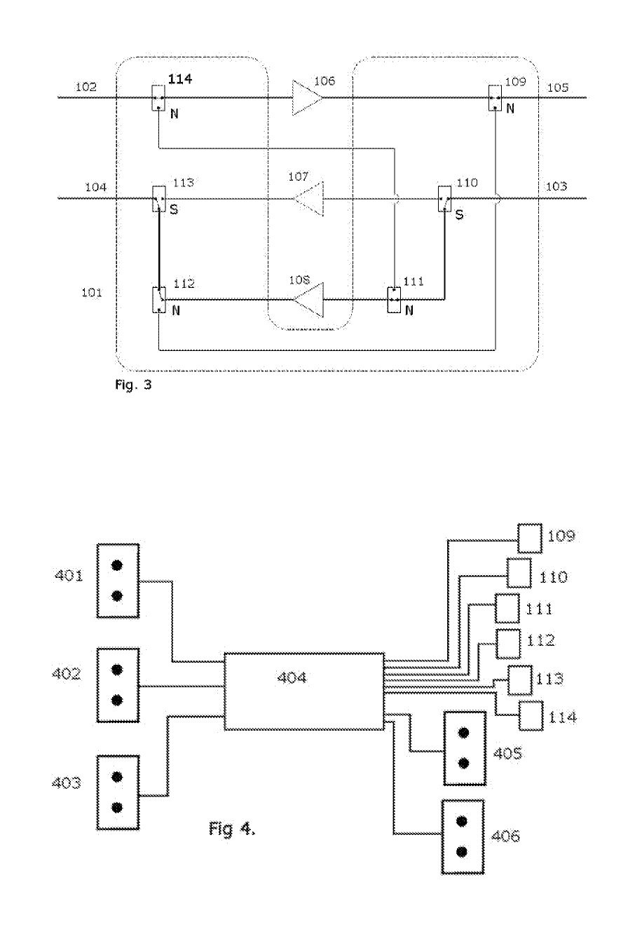

When the protection switch 101 is configured to protect westbound amplifier 107 or if 107 fails (FIG. 3), the signal coming in from 103 is diverted by switch 110, in switch mode indicated by a “S”, to switch 111, which is in normal mode indicated by a “N”, which sends the signal into amplifier 108. After amplification switch 112, again operating in normal mode, sends the signal to switch 113, operating in switch mode, and out 104.

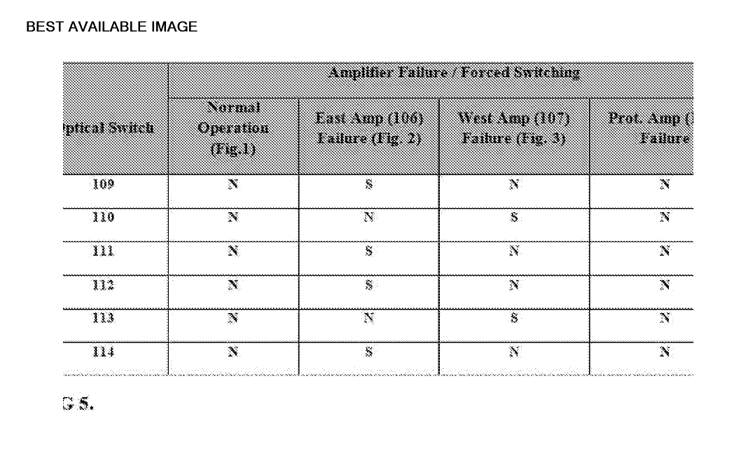

The method of changing the protection switch to the different configurations laid out in FIG. 1, FIG. 2, and FIG. 3, is done by electronic control circuit 404, FIG. 4. It is connected to three amplifiers by electrical alarm signal connection represented by 401, 402, and 403. When one of the working optical amplifiers fails, it generates an electrical alarm which is sent to 404 by connection 401 or 402 or 403 and 404 identifies which amplifier initiated the alarm and controls the appropriate 1×2 optical switches using electrical connection to the 1×2 switches 109, 110, 111, 112, 113, and 114 which are shown in more detail in FIGS. 1, 2 and 3. 404 also sends electrical alarm signals through 405 and 406 to any other external monitoring equipment that an amplifier has failed.

If there is a case where protection optical amplifier 108 fails, 404 will send out an alarm to 405 as well and lock the switch from changing communication over to the failed protection amplifier. If the protection switch loses power from one of its dual power feeds, 404 will send out an alarm to 406.

Once the protection switch moves communications to the protection amplifier, it will remain in that state until 404 is reset by an external button (called non revertive). If another amplifier should fail during that time, no switching will occur. Also 404 can be set to revert communication back to the working amplifier after a predefined time period, if the alarm from that amplifier has cleared.

In order to test the operability of protection switch, test buttons are installed to induce failures for the scenarios mentioned above. These buttons will simulate an alarm received from either the west, east, or protection amplifiers. This will allow installers and technicians the ability to verify the operability of amplifier 108 from time to time.

FIG. 5. is a table that demonstrates which position the optical switches are set to in the four different scenarios. The first, is the normal operation, in which all the switches are set to their normal positions as indicated by FIG. 1. Should amplifier 106 fail, the switches orient themselves according to the column titled “East Amp (106) Failure”, further illustrated by FIG. 2. Should amplifier 107 fail, the switches orient themselves according to the column titled “West Amp (107) Failure”, further illustrated by FIG. 3. Should amplifier 108 fail, the switches orient themselves according to the column titled “Prot. Amp (108) Failure”, further illustrated by FIG. 1. “N” indicates operating normally, and “S” indicates it is switched from its normal operation.

For the protection of an optical network with more than two optical amplifiers, the protective switch must be modified in order to accommodate the extra amplifiers. This is achieved by adding to and/or modifying the optical switches and combiners to the invention's design but does not deviate from the scope of this invention.

What is claimed is:

1. A fiber optic system with one or two working optical amplifiers at any location, fiber communication is protected from amplifier failure by having the working optical amplifier(s) connected up to a protection switch that will route the fiber signal coming from any failed working optical amplifier to a protection optical amplifier, keeping the fiber communication down time of the network to a short period of time, ideally undetectable for most protocols and data rates.

2. The protection switch in claim 1, wherein said protection switch is comprised of 1×2 optical switches that are electronically controlled that route the signal to and from the failed working optical amplifier to the protection amplifier.

3. The protection switch in claim 1, wherein said protection switch contains an electrical circuit that takes electrical alarm signals from the amplifiers, and uses those signals to determine if one of those amplifiers has failed. It then activates the correct combination of 1×2 optical switches in order to route fiber signals from one or two fibers to and from the protection optical amplifier.

4. The protection switch in claim 1, wherein said protection switch works for any type of amplifier and wavelength range.

5. The protection switch in claim 1, wherein said protection switch works for any number of channels on a multiplexed fiber.

6. The protection switch in claim 1, wherein said protection switch works for any data rate per channel.

7. The protection switch in claim 1, wherein said protection switch contains visual LED indicators to notify personnel when a failure has occurred.

8. The protection switch in claim 1, wherein said protection switch contains buttons on the chassis to use for testing and resetting of the protection switch.

9. The protection switch in claim 1, wherein said protection switch contains additional electrical alarm output contacts for connection to external monitoring equipment.
